(19) United States
(12) Patent Application Publication
(10) Pub. No.: US 2004/0055477 A1
(43) Pub. Date: Mar. 25, 2004

(54) Rotisserie oven

(76) Inventors: Phillip D. Swank, Germantown, WI (US); C. Philip Insisiengmay, Waukesha, WI (US); David Farchione, Jackson, WI (US); Michael Lemcke, Oak Creek, WI (US); B. Erich Rehm, West Bend, WI (US); Bill Hansen, Pewaukee, WI (US)

Correspondence Address: QUARLES & BRADY LLP, 411 E. WISCONSIN AVENUE, SUITE 2040, MILWAUKEE, WI, 53202-4497, US

(21) Appl. No.: 10/428,796

(22) Filed: May 2, 2003

Related U.S. Application Data
(63) Continuation-in-part of application No. 10/078,845, filed on Feb. 19, 2002, now Pat. No. 6,608,288.

(51) Int. Cl. A47J 37/04

(52) U.S. Cl. 99/419

(57) ABSTRACT

A rotisserie oven is presented having a spit assembly, heating assembly, drainage assembly, door assembly, and other features.

### CROSS-REFERNCE TO RELATED APPLICATIONS

This is a continuation-in-part of U.S. patent application Ser. No. 10/078,845, filed Feb. 19, 2002 and entitled “Oven Chamber Having a Pass-Through Design”, and further claims priority to a U.S. Provisional Patent Application filed Apr. 22, 2003 under Quarles & Brady, LLP Docket No. 110074.90155 and entitled “Grease Collection System for Oven”, the disclosures of each of which are hereby incorporated by reference as if set forth in their entirety herein.

### BACKGROUND OF THE INVENTION

The present invention relates generally to cooking apparatuses, and in particular to rotisserie ovens.

Rotisserie ovens are traditionally used to cook raw meet product, such as chicken, duck, and the like. Conventional rotisserie ovens suffer from several drawbacks. For instance, if the door to the cooking cavity is not sufficiently sealed, flavorful gasses may escape from the oven. Furthermore, conventional ovens allow condensation to accumulate on the interior surface of the glass door, thereby inhibiting a user's ability to visually inspect the food without opening the door. Conventional ovens further suffer from drawbacks related to the drainage of grease that accumulates in the cooking chamber, and further drawbacks related to difficulties experienced when cleaning the cooking chamber.

It is thus desirable to overcome these deficiencies and to make further improvements upon conventional rotisserie ovens.

### BRIEF SUMMARY OF THE INVENTION

In one aspect the invention provides a rotisserie oven incorporating features not present in conventional ovens, and therefore provides advantages not heretofore realized in conventional ovens.

The foregoing and other aspects of the invention will appear from the following description. In the description, reference is made to the accompanying drawings which form a part hereof, and in which there is shown by way of illustration, and not limitation, a preferred embodiment of the invention. Such embodiment does not necessarily represent the full scope of the invention, however, and reference must therefore be made to the claims herein for interpreting the scope of the invention.

### BRIEF DESCRIPTION OF THE DRAWINGS

FIG. 1 is a perspective view of a rotisserie oven constructed in accordance with a preferred embodiment stacked on top of a warming chamber, wherein a spit assembly is installed in the rotisserie oven;

FIG. 2 is a perspective view of the control portion of the rotisserie oven illustrated in FIG. 1;

FIG. 3 is a perspective view of the control portion of the rotisserie oven illustrated in FIG. 1 having a spit assembly installed;

FIG. 4 is a perspective view of a motor that drives the spit assembly illustrated in FIG. 3;

FIG. 5 is a perspective view of a coupling that engages the motor illustrated in FIG. 4;

FIG. 6 is a perspective view of a disc that is connected to the coupling illustrated in FIG. 5;

FIG. 7A is another perspective view of the disc illustrated in FIG. 6;

FIG. 7B is a side elevation view of the disc illustrated in FIGS. 6 and 7A;

FIG. 8 is a perspective view of a power transfer shaft having a drive end that engages the disc illustrated in FIG. 6, and a driven end;

FIG. 9 is a perspective view of the shaft illustrated in FIG. 8;

FIG. 10 is a perspective view of a portion of the cooking chamber illustrating a bearing that engages the driven end of the power transfer shaft illustrated in FIGS. 8 and 9;

FIG. 11 presents various views of an angled spit that form a part of the preferred embodiment of the invention;

FIG. 12 is a perspective view of an assembled spit assembly having a plurality of angled spits and dual pronged spits mounted in accordance with a preferred embodiment of the invention;

FIG. 13 is a perspective view of the assembled spit assembly illustrated in FIG. 12 having a plurality of baskets mounted in accordance with a preferred embodiment of the invention;

FIG. 14A is a perspective view of the upper and left side walls of the cooking chamber having a lighting assembly, convection heating system, radiation heating system, and steam cleaning system;

FIG. 14B is a perspective view of the left side wall of the oven housing in accordance with an alternate embodiment of the invention;

FIG. 15 is a perspective view of a convection heating assembly installed in the cooking chamber;

FIG. 16 is a perspective view of the fan blades used in combination with the convection heating system illustrated in FIG. 15;

FIG. 17 is a perspective view of the convection heating system illustrated in FIG. 14A with a cover plate installed;

FIG. 18 is a perspective view of the upper wall of the cooking chamber illustrating the lighting system and radiation heating system;

FIG. 19 is a perspective view of a front door assembly of the oven illustrated in FIGS. 1-3;

FIG. 20 is a perspective view of a temperature probe assembly installed onto the door assembly, and further of an internal airflow system integrated with the door assembly illustrated in FIG. 19;

FIG. 21 is a perspective view of the door handle portion of the door assembly illustrated in FIG. 19;

FIG. 22 is an assembly view of various components of the door assembly illustrated in FIGS. 19-21;

FIG. 23 is a perspective view of a waste pan having a drainage valve constructed in accordance with a preferred embodiment of the invention, wherein the valve is in a closed position;

FIG. 24 is a perspective view of the waste pan illustrated in FIG. 23, wherein the valve is in an open position;

FIG. 25 is a schematic view of a mechanical humidity control module constructed in accordance with an alternate embodiment of the invention;

FIG. 26 is a perspective view of the drive assembly portion of the spit assembly constructed in accordance with an alternate embodiment of the invention mounted onto the oven;

FIG. 27 is another perspective view of the drive assembly illustrated in FIG. 26; and

FIG. 28 is an end elevation view of the drive assembly illustrated in FIGS. 26-27.

### DETAILED DESCRIPTION OF THE PREFERRED EMBODIMENT

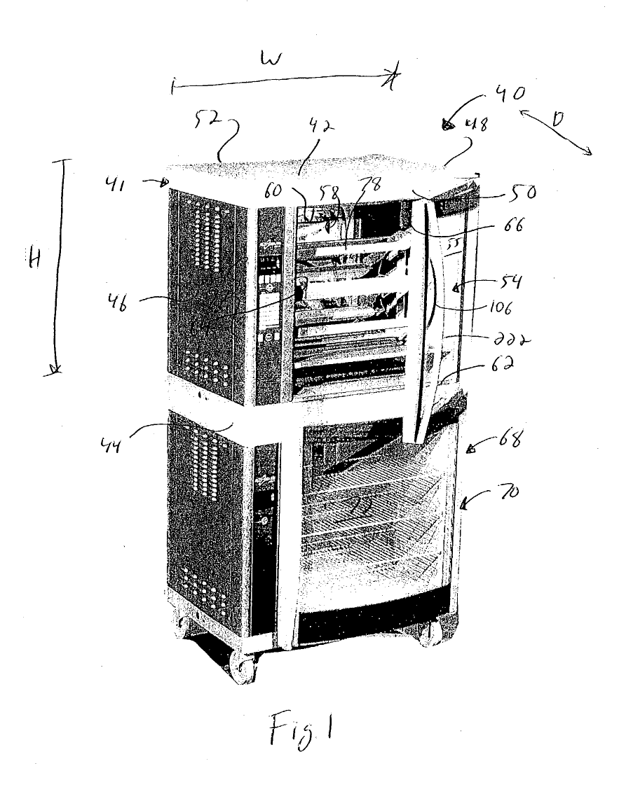

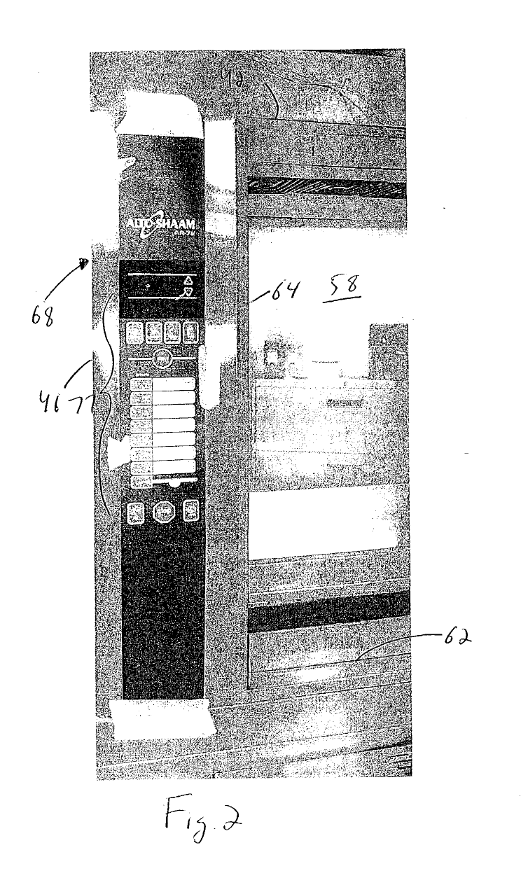

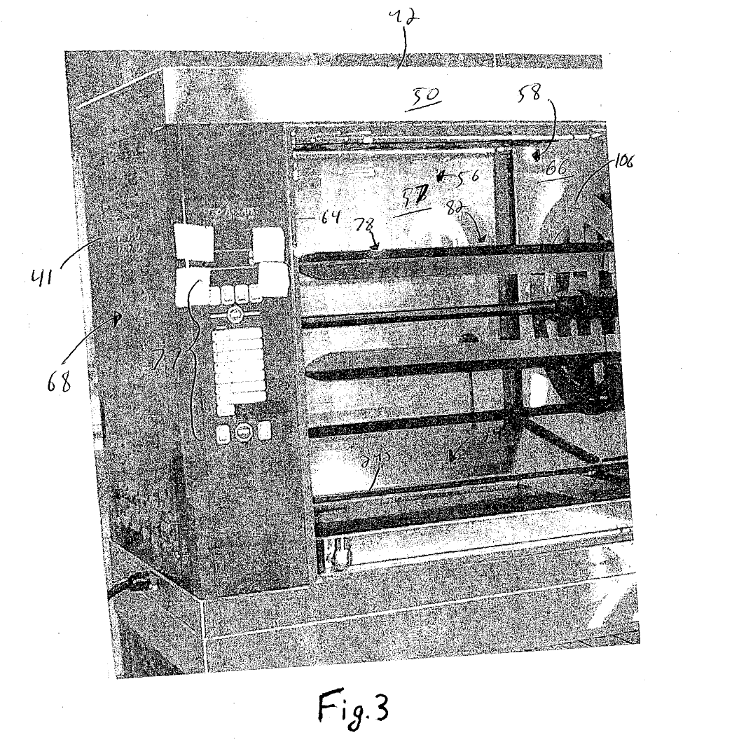

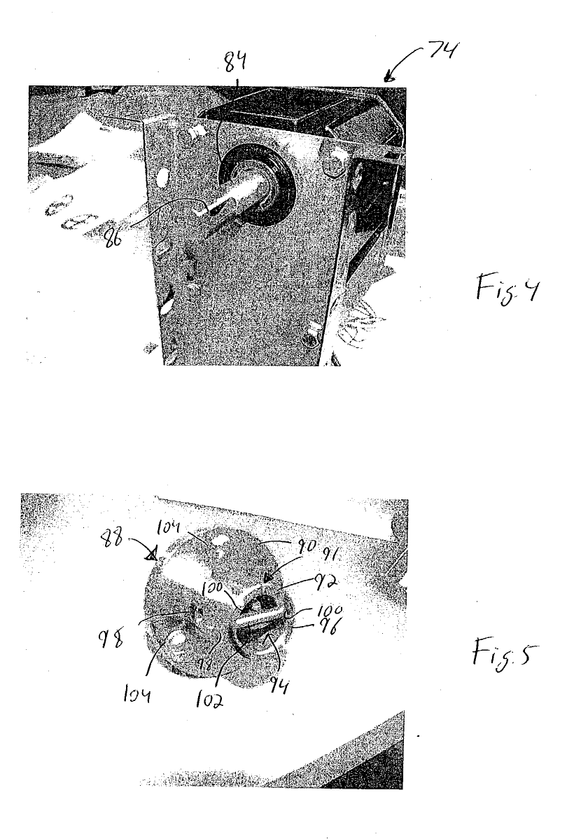

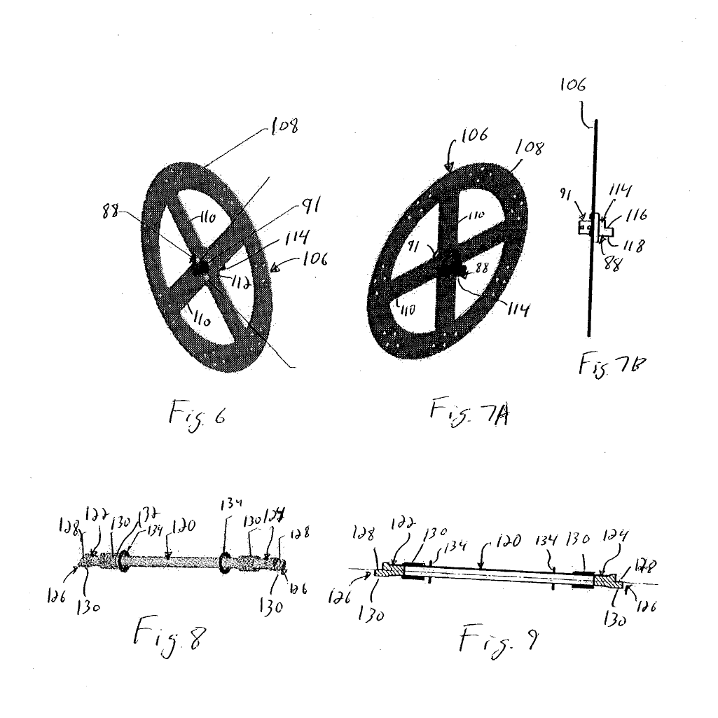

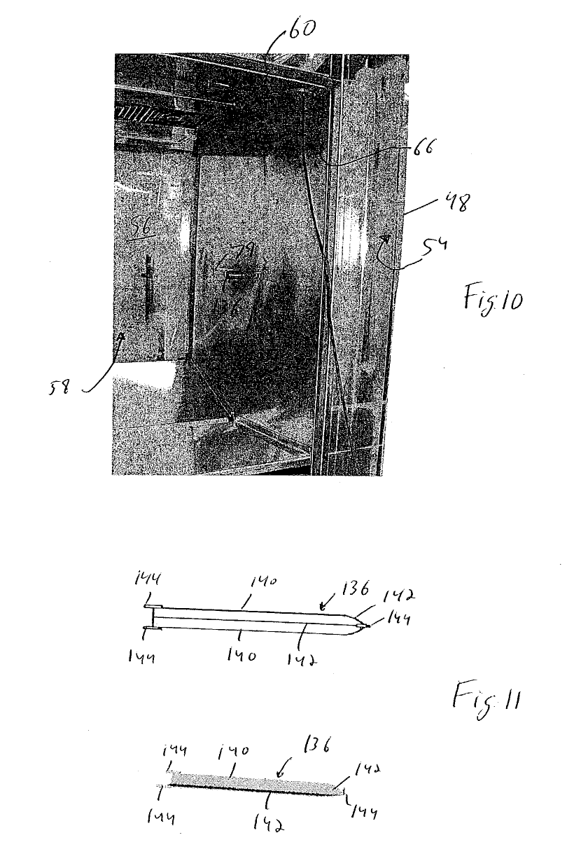

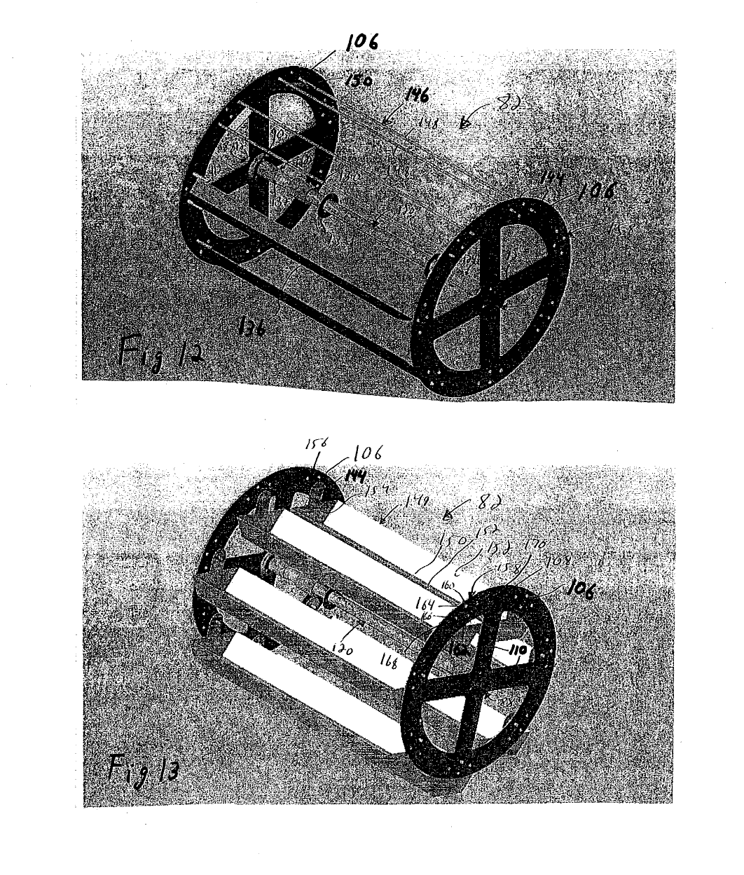

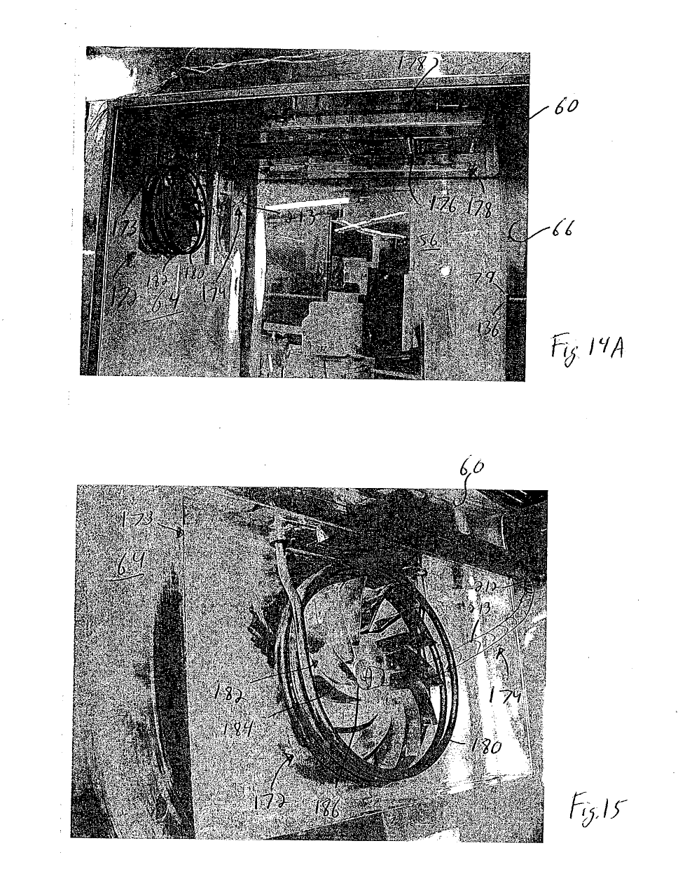

Referring initially to FIG. 1, a rotisserie oven 40 includes an outer housing 41 having upper and lower walls 42 and 44, respectively, opposing left and right side walls 46 and 48, respectively, and opposing front and rear walls 50 and 52, respectively. A front door assembly 54 connected to the front wall 50, and a rear door assembly 56 is carried by the rear wall 52 to provide access to a cooking chamber 58. Door assemblies 54 and 56 include transparent window assemblies 55 and 57, respectively that provide visible access to the cooking chamber 58.

Cooking chamber 58 includes opposing upper and lower walls 60 and 62, respectively, opposing left and right side walls 64 and 66, respectively, and may be sealed at its front and rear ends by front and rear door assemblies 54 and 56, respectively. Oven 40 thus has a pass-through design as described in U.S. patent application Ser. No. 10/078,845, and thus may further be used in accordance with the methods described in patent application Ser. No. 10/078,845. Oven has a width W that is defined by an axial direction, a height H that is defined by a vertical direction, and a depth D that is defined by a lateral direction.

The rotisserie oven 40 is mounted on top of a warming chamber 68 including a housing 70 of generally the same size and shape as housing 41, and a warming chamber 72 of generally the same size and shape of cooking chamber 58. Advantageously, the rotisserie oven 40 and warming chamber 68 may be stacked on top of each other. Ovens 40 and 72 are modular, such that oven 40 has rotisserie heating components installed and warming chamber 72 may have conductive or radiation heating assemblies installed that are configured to maintain food product that was prepared in the rotisserie oven. Oven 40 may be directly mounted on to a support assembly rather than stacked on another oven or warming chamber.

Referring now to FIGS. 2 and 3, a cabinet 68 is disposed between left side wall 46 of the oven housing 41 and left side wall 64 of the cooking chamber 58. Cabinet 68 houses a control assembly (not shown) that controls various aspects of the oven 40, such as temperature control, cooking sequences, and cleaning functions as is described in more detail below. Cabinet 68 further houses a motor 74 (See FIG. 4) that drives a spit assembly 82. The motor and heating elements are operated via a set of user controls and outputs 77 that are disposed on the front wall 50 of the housing 41 and located at the cabinet 68. A temperature sensor 79 is mounted onto the right side wall 66 for sensing the temperature in cooking chamber 58. The temperature may be displayed at the user outputs 77.

Spit assembly includes a plurality of spits (collectively identified as 78) that span between side walls 46 and 48 of the cooking chamber 58. Specifically, spits 78 span between a pair of support discs 106 (one shown) and are suitable for retaining meet product such as chicken, turkey, duck, and the like. Discs 106 are rotated under power supplied by motor 74, which form a portion of a spit assembly 82.

The construction of spit assembly 82 (described herein as extending in an axial direction) will now be described with reference to FIGS. 4-13. In particular, FIG. 4 illustrates a motor 74 that has a rotating output shaft 84 that extends outwardly from the motor and through left side wall 64 of the cooking chamber 58 when installed in the cabinet 68. The outer end of shaft 84 includes an elongated groove 86 that bifurcates the shaft.

Referring to FIG. 5, a coupling 88 includes a cylindrical mounting plate 90 and a shaft portion 92 extending outwardly from the mounting plate to form a motor connector 91. A bore 94 is formed in the outer end 96 of the shaft portion 92. A front and rear pair of opposed apertures 98 and 100, respectively, extend through shaft portion 92, either or both of which may receive a dowel 102. The inner diameter of outer end 96 is slightly greater than the outer diameter of output shaft 84, such that the output shaft 84 is received by outer end 96. Dowel 102 is received by groove 86 to interlock the coupling 88 with the output shaft 84, such that coupling 88 rotates along with output shaft 84 during operation. The mounting plate portion 90 of coupling 88 includes a plurality of apertures 104 extending axially therethrough.

Referring now to FIGS. 6-7B, a disc 106 includes an annular outer ring portion 108 and a pair of ribs 110 that extend perpendicular to each other and are connected at their outer ends to ring portion 108. Ribs 110 intersect at a hub 112, which is centrally disposed relative to the disc. A pair of discs 106 are provided in accordance with the preferred embodiment, one of which being disposed at the drive end of the spit assembly 82, the other of which being disposed at the driven end of the assembly.

Coupling 88 is mounted onto the outer surface of hub 112 such that dowel 102 faces outwardly and engages the motor 74 as described above. Coupling further includes a shaft connector 114 that extends from the opposite side of mounting plate 90 with respect to motor connector 91. Connector 114 is generally cylindrical, and defines an outer end that defines a flat axially extending engagement surface 116 as illustrated in FIG. 7B. Outer end of surface 116 is connected to a round member 118 that is in the shape of a half-cylinder.

Referring now to FIGS. 8 and 9, a power transfer shaft 120 includes a first end 122 disposed proximal the motor, and a second distal end 124 opposite the first end 124 that is disposed remote from the motor and proximal the right side wall 66 of cooking chamber 58. The shaft 120 is symmetrical with respect to both ends 122 and 124, hence only proximal end 122 is described herein. Specifically, a connector 126 is disposed at the outer end that includes an axially extending flat surface 128 and half-cylindrical surface 130. The flat surface 128 is configured to engage flat surface 116 of coupling 114, such that the connector 114 and connector 126 form a cylinder when connected.

A collar 130 is disposed on shaft 120 having an internal bore shaped to match the outer surface of the joint between connector 126 and coupling 88. Collar 130 is thus slid over the joint to secure the connector 126 to the coupling 114. End 122 presents a radial groove 132 that is disposed inwardly of the collar 130 (once placed in engagement with the joint) as illustrated in FIGS. 12 and 13. A locking ring 134 is slid into engagement with the groove 132 to prevent the collar 130 from sliding away from the joint during use.

Referring now also to FIG. 10, distal end 124 is joined to a coupling 88 as described above. The shaft portion 92 is connected to a cylindrical bearing 136 that extends into the cooking chamber 58 from right side wall 66. Bearing 136 includes a pair of apertures (not shown) that are configured to correspond with apertures 98 and 100 of the shaft portion 92 of coupling 88. Bearing 136 has an outer diameter less than the inner diameter of bore 94 such that the bearing 136 is received by bore 94. Dowel (not shown in FIG. 11) thus extends through the bearing aperture along with either or both of apertures 98 and 100 to lock the coupling 88 to the bearing 136 with respect to rotational motion.

Referring also to FIGS. 12-13, during assembly, the couplings 88 are first mounted onto hubs 112 of discs 106 as described above. The shaft portions 92 of couplings 88 are then connected to motor 74 and bearing 136, respectively. The shaft 120 is then installed, such that ends 122 and 124 are connected to the shaft connectors 114 of couplings 88. The spit assembly 82 may be disassembled by reversing the assembly process, for instance when it is desired to clean the cooking chamber 58.

Referring now also to FIG. 11, the assembled spit assembly 82 is illustrated having various spits 78 extending between the discs 106. In particular, a first angled spit 138 includes a pair of elongated axially extending flat walls 140 that join at an axially extending apex 142 to assume the general shape of an elongated bracket. Walls 140 define a pointed end 142 that is disposed at one end of spit 138. A mounting pin 144 extends outwardly from the pointed end 142. The other end of the spit 138 includes a pair of mounting pins 144 extending outwardly (one from each wall 140).

A second dual-prong spit 146 includes a pair of cylindrical skewer rods 148 that are joined by a rib 150 at one end. A mounting pin 144 extends outwardly from either end of each rod 148. The mounting pins 144 disposed remote from rib 150 may be pointed to assist in piercing uncooked food product. Mounting pins 144 of spit 146 are spaced apart the same distance as mounting pins 144 of spit 138.

A third spit is a basket 149 that includes an axially elongated base 150 integrally connected to opposing side walls 152 that are angled outwardly with respect to the base. A pair of opposing end walls 154 closes the basket 149. Food product sits in the basket 149 during operation. A slot or plurality of slots (not shown) extends axially between the base 150 and side walls 152 to assist in the drainage of grease that is produced during the preparation of the food product. A mounting flange 156 extends upwardly from each end wall 154, and supports a mounting pin 144 that extends outwardly from the flange 156. Mounting pins 144 enable rotation of the corresponding spit 78.

Discs 106 define a plurality of spit mounting locations 158 located at the outer ring portion 108 and radially offset from each other (seven illustrated). Each mounting location 158 includes two pairs of apertures designed to receive mounting pins 144. In particular, a first pair of apertures 160 includes first and second radially aligned apertures 162 and 164, respectively. First aperture 162 is disposed radially inwardly with respect to second aperture 164. A second pair of apertures 166 includes tangentially aligned apertures 168 and 170.

Apertures 168 and 170 are designed to receive mounting pins 144 of the dual-pronged ends of spits 138 and 146. Apertures 162 and 164 are designed to receive mounting pins 144 of the single-pronged ends of spits 138 and 149. Advantageously, for larger food product, spit 138 may be orientated with the single mounting pin 144 of the pointed end 142 in the radially outer aperture 164. In this first configuration, the apex 144 points radially inwardly to position the food product away from the radiating heat elements, as will be described below. Alternatively, for smaller food product, mounting pin 144 of the pointed end 142 may be positioned in the radially inner aperture 162 such that apex 142 faces outwardly, thereby positioning the food product closer to the radiating heat elements. Sufficient clearance exists such that one end of the spits may be translated close to the corresponding disc 106 to free the mounting pins 144 at the other end of the spit from the opposite disc 106. Accordingly, spits may be easily attached to and removed from assembly 82.

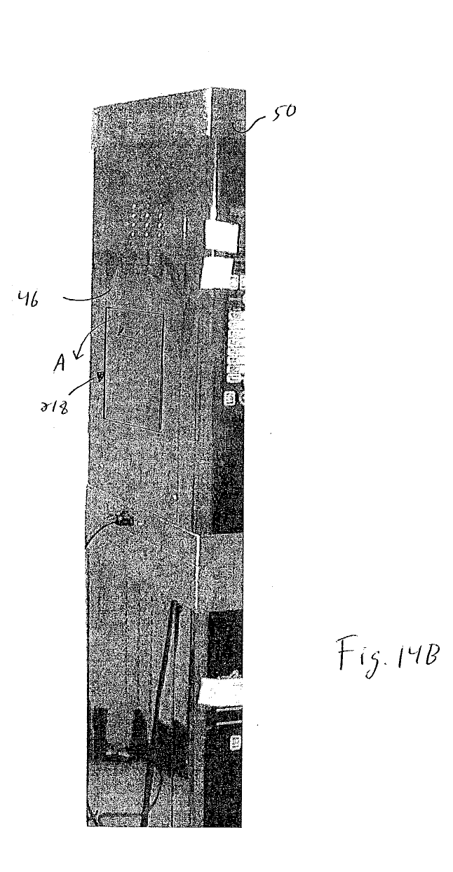

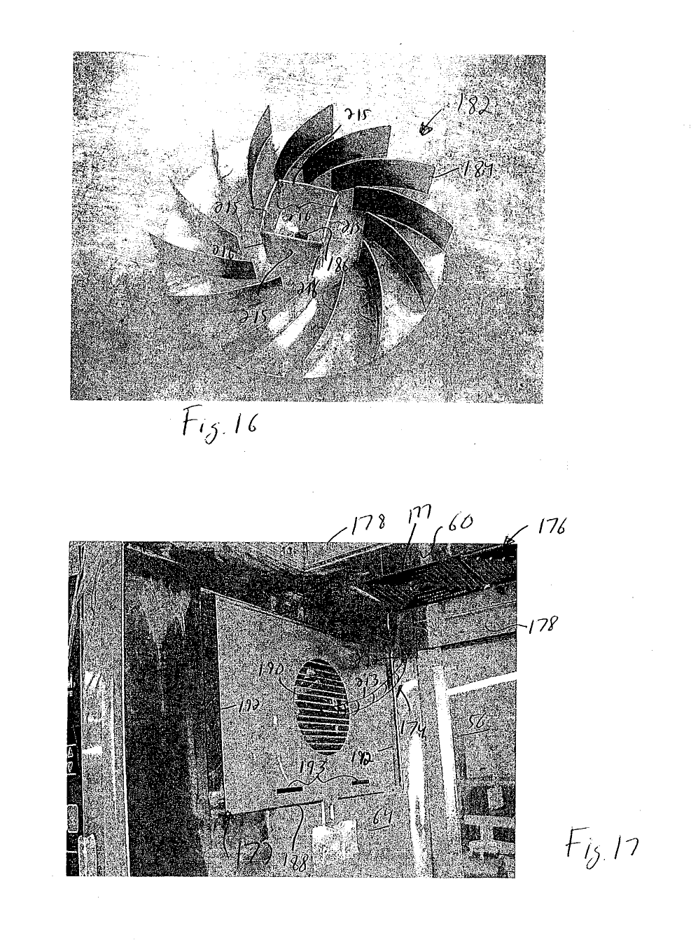

Referring now to FIG. 14A, oven 40 includes a convection heating assembly 172 and steam producing assembly 174, both disposed on left side wall 64 of cooking chamber 58. Heating assembly 172 is disposed in a rectangular recess 173 formed in the left side wall 64. A radiating heat source 176 and a pair of lighting assemblies 178 are both disposed in the upper wall 60 of cooking chamber 58. Specifically, radiating heat source 176 is laterally centrally disposed with respect to upper surface 60, and extends axially between side walls 64 and 66. A lighting assembly 178 is disposed on each either lateral side of radiating heat source 176. Each lighting assembly extends axially between side walls 64 and 66 and parallel to radiating heat source 176.

Referring now to FIGS. 15-17, the convection heating assembly 172 includes a standard resistive coil 180 in the form of a loop that is connected to the controller and produces heat in response to an electrical input. A fan 182 is disposed inside the loop that is formed by the coil 180, and includes fan blades 184 that rotate about a hub 186. Fan is thus rotatably mounted to left side wall 64 of cooking chamber 58. A cover 188 is mounted on the left side wall 64 and houses the convection heating assembly 172. A plurality of grooves 190 extend through the cover 188 that are generally axially aligned with fan 182. Grooves 190 provide an air intake for the fan 182. The cover 188 does not span laterally the entire distance of recess 173 so as to expose vertically extending gaps 192 that are disposed between the cover 188 and left side wall 164 on both lateral sides of fan 182 to provide an air outlet. Horizontal slots 193 are also formed in cover to provide additional air outlets. Accordingly, during operation, fan blades 184 rotate to draw air into the fan 182 via intake grooves 190. The air is expelled radially outwardly by the fan blades 184, thereby forcing the air to flow across resistive coil 180 before being expelled into the cooking chamber 58 via air outlet gaps 192 and 193 to heat the food product.

Referring now to FIG. 18, the radiation heat source 176 includes a plurality of rectangular ceramic disks 177 that surrounds traditional resistive coils. Ceramic heaters 177 are of the type commercially available from OGDEN Corp, located in Arlington Heights, Ill. or Chromalox, Inc. located in Pittsburgh, Pa.

Accordingly, bottom of the coil (when positioned as installed in the cooking chamber 58) is essentially coated with a ceramic material which has been found to emit infrared heat that is less scattered compared to coils that are not embedded in ceramic. The food product is thus browned more uniformly than conventionally achieved. The coils are connected via electrical leads to the control, and emit heat upon an electrical input. The cooking chamber 58 thus advantageously incorporates a convection heat source 172 that is used to cook raw food product along with a radiation heat source 176 that browns the food being prepared. The angled spit 138 may be positioned in the discs 106 depending on the desired distance between heat source 176 and the outer surface of the food product.

The present invention recognizes that the heating assemblies 172 and 176 are rated for a predetermined wattage output. Furthermore, it is desirable to ensure the consistency of the food preparation process. Because the oven 40 may be used worldwide in electrical receptacles that deliver electrical currents having varying input voltage levels, the control assembly senses the input voltage and delivers electrical pulses to the heating assemblies 172 and 176 to regulate the effective voltage that is applied to the heating assemblies. Increased input voltage levels will cause the controller to reduce the pulse frequency, and vice versa. Accordingly, a consistent desired wattage output of the heating assemblies is advantageously maintained. The pulses may either be delivered independently to each heating assembly 172 or 176. Alternatively, a combined pulse may be sent to both heating assemblies 172 and 176. Furthermore, the controller is connected to motor 74 of spit assembly 82 via a DC motor that pulses power to the motor in response to a user input on the user controls 77. The user may thus regulate the speed of spit rotation.

Referring to FIG. 18, each lighting assembly 178 is disposed in a recess 194 that is formed in the upper wall 60 of cooking cavity 58. Recess 194 defines a pair of end walls 196 and 198, upper wall 200, and opposing side walls 202 and 204. A pair of sockets 205 extends into the recess 194 from end walls 196 and 198. Advantageously, the sockets receive standard Edison Socket style of light bulbs as well as more expensive Halogen bulbs. The recess 194 is closed at its bottom via a glass cover 206 that is hingedly connected to the lower edge of side wall 202, and connected to the lower end of side wall 204 via a latch 208. Accordingly, the glass cover 206 may be opened and closed as desired to replace the bulbs 210.

Advantageously, the bulbs 210 are disposed above the radiation heat source 176, and are thus not exposed to direct infrared heating. Furthermore, the recess 194 and glass cover 206 shield the bulbs 210 from the convection heat source 172. Accordingly, the bulbs 210 are not as susceptible to breakage as conventional designs whose bulbs are placed in the cooking chamber in the direct path of heat from the heat source. Furthermore, when bulbs of conventional ovens break during a food preparation sequence, the bulb particles become scattered on the food, which must therefore be discarded. In accordance with the preferred embodiment, if bulbs 210 were to somehow break, the remnants would be prevented from entering the cooking chamber 58, thereby preserving the food being prepared.

Referring again to FIGS. 14A, 15, and 17, the present invention recognizes the difficulties associated in removing grease that was produced during a cooking sequence from the walls of the cooking chamber 58. Accordingly, a steam producing assembly 174 is provided that introduces steam into the cooking chamber 58 once a user initiates a cleaning cycle via user controls 77. In order to ensure that steam is not produced during the cooking cycle, the controller will prevent steam from being produced until the temperature in the cooking chamber 58 is below a predetermined threshold.

Steam assembly 174 includes a water outlet 212 disposed in the left side wall 64 of cooking chamber 58. A conduit 213 extends from cooking chamber 58 to the hub 186 of fan 182. Referring to FIG. 16, a plurality of side walls 215 surrounds the hub 186 of fan 182 so as to create a housing 214 with an open upper end that receives water from conduit 213. A slot 216 extends through the interface between adjacent side walls 215. Accordingly, water entering the housing 214 via conduit 213 is “slung” through slots 216 where it contacts the heating coil 180 to produce steam that is emitted into the cooking chamber 58 via gaps 192 and 193. It has been found that the introduction of steam into a chamber increases the efficiency of grease removal.

Water outlet 212 may receive water from a waterline (e.g., faucet), or alternatively from a water tank that is either located external to the oven 40, or mounted in cabinet 68, as illustrated in FIG. 14B. In particular, a hatch 218 is formed in left side wall 46 of housing 41 that may be opened in the direction of Arrow A. Water may be delivered into the hatch to fill an internal water tank (not shown) that is connected to outlet 212. In this embodiment, it may be desirable to position the tank proximal the upper wall 42 and/or position the outlet 212 further from upper wall 60 in order to produce downward water pressure that causes the water to flow from the tank to the outlet 212 without the need for additional pumps.

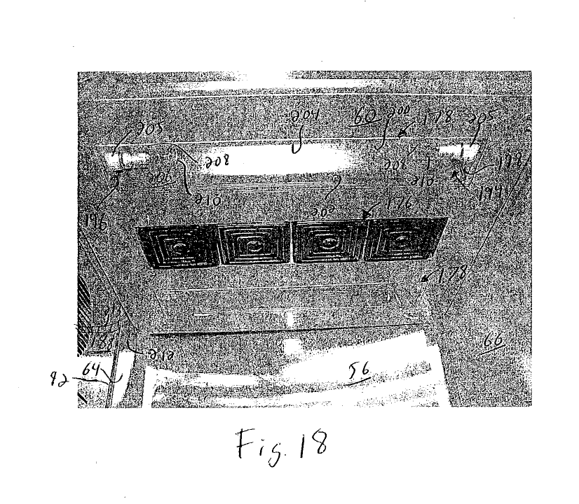

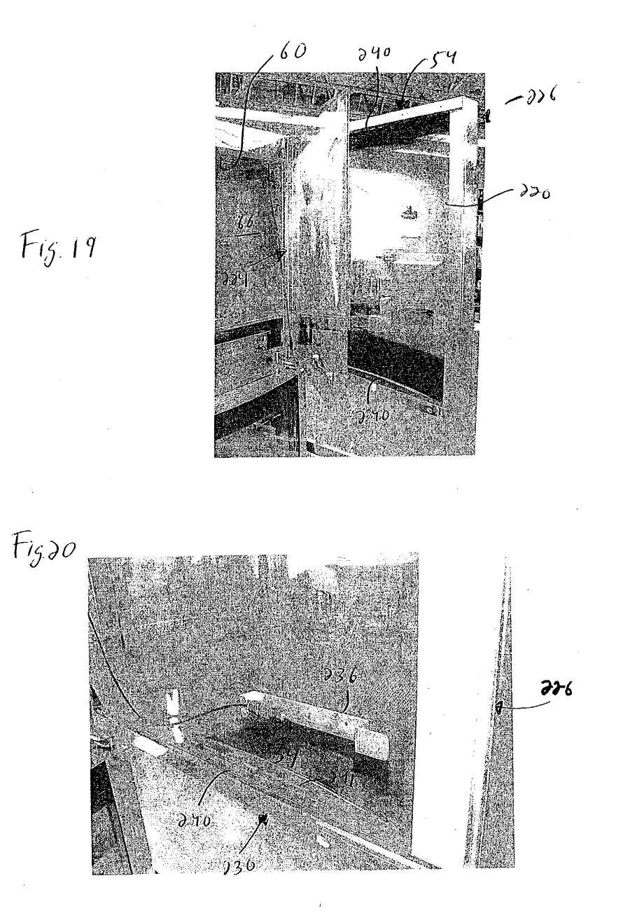

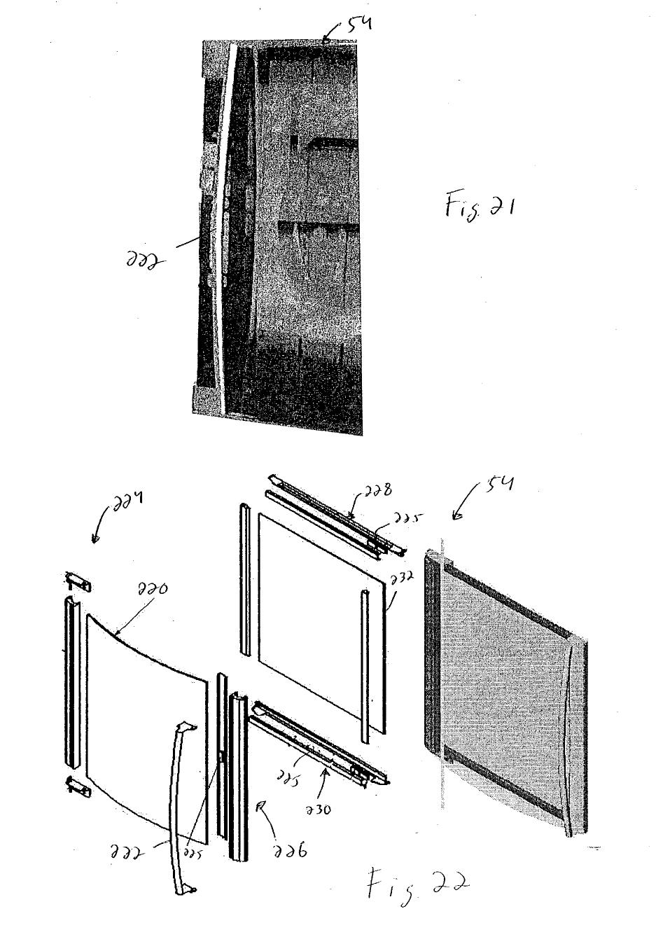

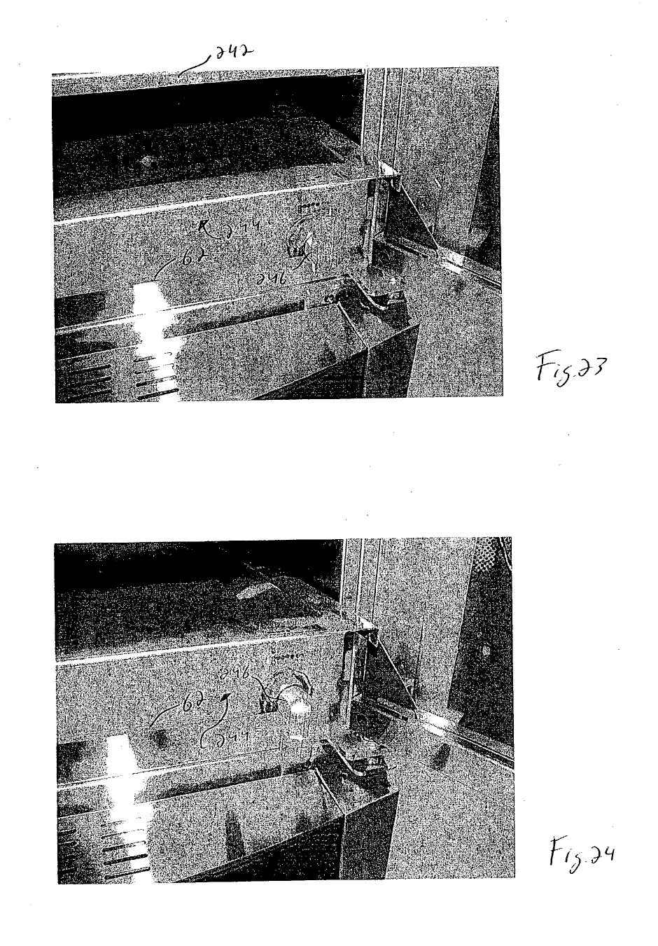

Referring now to FIGS. 19-22, the front door assembly 54 includes a glass member 220 that is bowed laterally outwardly. A door handle 222 is connected to one end of the outer surface of glass member 220. Vertically extending door frame members 224 and 226, and horizontally extending upper and lower door frame members 228 and 230, respectively, surround glass member 220. A second flat glass member 232 is provided that is hingedly connected to the inner surface of one of the vertical door frame members 224. Flat glass member 232 is thus positioned between frame 41 and bowed glass member 220.

A plurality of magnets 225 is disposed in door frame members 226, 228, and 230. No magnets are disposed in hinged door frame member 224. The magnets 225 are sensed at the housing 41 and communicated to the controller to automatically determine when the door 54 is open. The magnets 225 further bond glass member 220 to glass member 232, and furthermore bond the door assembly 54 to the housing 41. A strip of silicon rubber is applied to the front wall 50 of housing 41 around the opening of the door 54 that interfaces with door frame members 226, 228, and 230 (and optionally 224). Accordingly, when the door assembly 54 is closed, the rubber forms a tight seal with the door assembly to prevent leakage from the cooking chamber 58 of flavored gasses that are emitted during food preparation.

Accordingly, flat glass member 232 hinges relative to bowed glass member 220. Both glass members 232 and 220 hinge relative to door frame member 224 which is mounted to housing 41. A temperature sensor 234 is removably mounted to a bracket 236 that is connected to the inner surface of flat glass member 232. Sensor 234 is connected to the controller via an electrical lead 238. The controller is programmed to automatically measure and display the temperature of the cooking chamber 58 until the door assembly 54 is opened, at which point the control will display the temperature of sensor 234, which may be embedded in the food product to measure the temperature of the food product during preparation. Of course, the user may change these default settings if desired.

A pair of plates 240 extends between the base and top of door frame members 224 and 226, and present a flat surface that abuts the outer surface of flat glass member 232. The plates include perforations 241 that enable fresh ambient air to flow between glass members 220 and 232, thereby reducing condensation at the door assembly 54 and enabling a user to visually inspect the contents of the oven 40 during food preparation. Alternatively, plates 240 may be removed to create openings between the glass members 220 and 232 to increase the air flow, if desired.

It should be appreciated that the rear door assembly 56 may be constructed in the manner described with reference to front door assembly 54.

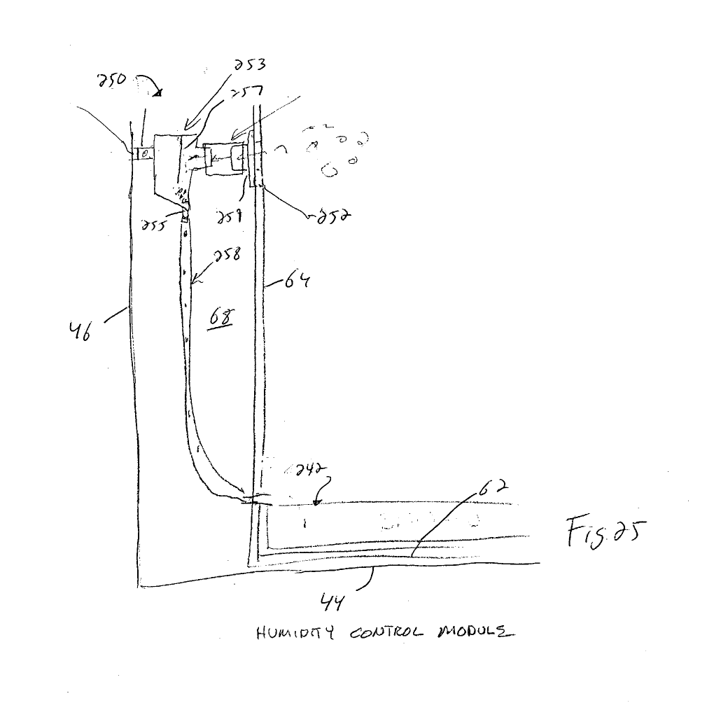

Referring now to FIGS. 3, 23, and 24, a drain pan 242 is disposed above the base 62 of cooking chamber 58, and is angled downwardly from both door assemblies 54 and 56 toward the middle of the chamber. A groove 245 extends axially at the apex of the drain pan 242. A waste pan 244 is essentially a rectangular housing with an open top that is disposed between base 62 and the drain pan 242, and provides a receptacle that receives grease and other cooking byproducts from the groove in drain pan 242. Waste pan 244 may be easily removed from and inserted into the gap between base 62 and drain pan 242. Alternatively, drain pan 242 could include a trough at its base that in connected to a conduit which, in turn, connects to a proper grease disposal site.

A valve 246 is disposed in the front surface 248 of the drain pan 242 at a location towards the base. The valve 246 provides a conduit that extends outwardly from the waste pan 244 and upwardly when it is desired to store the contents in the waste pan. Once it is desired to drain the waste pan, the valve 246 is rotated downwardly as illustrated in FIG. 24 which enables fluid to flow through the valve and into a conduit or a portable receptacle for the removal of grease. The base of waste pan may be angled downwardly towards valve 246 to force fluid to flow into the valve. Alternatively, oven 40 may include a grease removal system of the type described in U.S. Provisional Patent Application filed Apr. 22, 2003 under Quarles & Brady, LLP Docket No. 110074.90155 and entitled “Grease Collection System for Oven”.

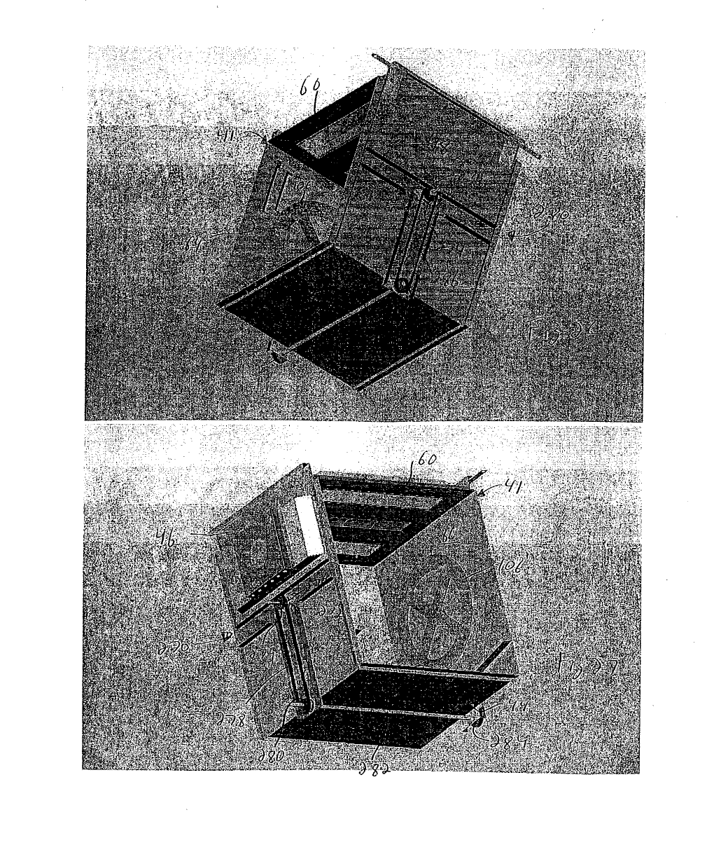

Referring now to FIG. 25, oven 40 may include a humidity control module 250 having a vapor intake channel 252 left side wall 64 of cooking chamber 58. Intake channel 252 is connected to an adapter 259 disposed in cabinet 68 which, in turn, is connected to a conduit that flows into a condensing box 253. Condensing box 253 has an outlet 255 at its lower end that is connected to a conduit 258 that extends through side wall 64 and delivers fluid to drain pan 242 or, alternatively, directly into waste pan 244.

During operation, steam flows into intake channel 252 and eventually into condensing box 253. Condensing box includes a separator plate 257 extending downwardly that directs the steam downwardly. The temperature of condensing box may be regulated so as to ensure condensation of the incoming steam. Alternatively, a blower 260 is provided that draws air from the cooking chamber 58 into the condenser 253 to condense the steam in the air, and vents the air out cabinet 68. The control module may sense the humidity level inside cooking chamber 58 and adjust the speed of the blower accordingly to maintain a desired humidity level. Alternatively, the inlet may be sloped upwardly so as to enable a greater amount of steam (which flows upwardly in chamber 58) to enter the humidity control module 250. The water that is formed in condenser 253 flows downwardly through conduit 258 and ultimately into drain pan 242. The removal of humidity in the cooking chamber 58 reduces the condensation likely to accumulate on door assemblies 54 and 56.

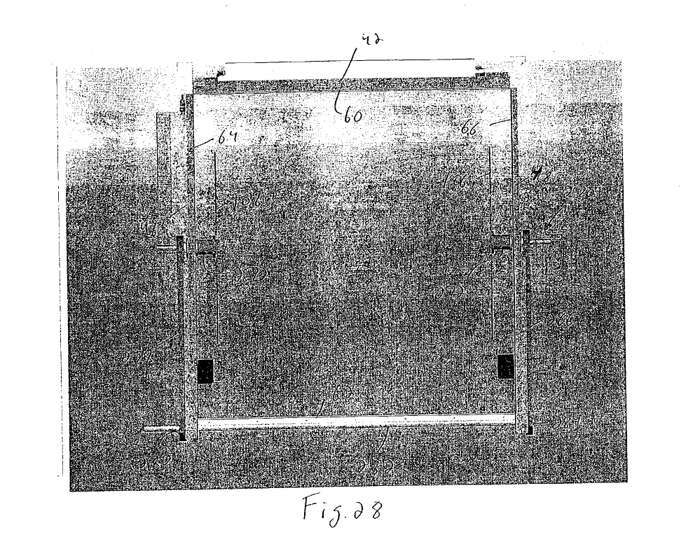

Referring now to FIGS. 26-28, a spit assembly 270 is illustrated in accordance with an alternate embodiment. The assembly includes all components described above with respect to spit assembly 82 (unless otherwise mentioned), except assembly 270 does not require power transfer shaft 120 to extend through cooking chamber 54. As a result, additional space is reserved for food product that is to be prepared. Specifically, a coupling 272 is presented that is connected to disc 106 in the manner described above with reference to coupling 88, however coupling 272 includes a pulley 274 disposed outside of chamber 58 that presents a belt engagement surface 276. A drive belt 278 extends downwardly to a pulley 280 that is mounted to left side wall 46 and extends beneath the lower wall 44 of housing 41. Pulley 280 is connected to a rod 282 that extends beneath lower wall 44 to a pulley 284 that is connected to right side wall 48 and aligned with pulley 280. A driven belt 286 extends from pulley 284 to a coupling 272 that is connected to a disc 106 that is mounted to the inner surface of right side wall 66. Accordingly, the discs 106 (and remaining portions of spit assembly 270) are caused to rotate without the need for a shaft to span between the discs 106 in the cooking chamber 58.

The above description has been that of the preferred embodiment of the present invention, and it will occur to those having ordinary skill in the art that many modifications may be made without departing from the spirit and scope of the invention. In order to apprise the public of the various embodiments that may fall in the scope of the present invention, the following claims are made.

We claim:

1. A rotisserie oven of the type illustrated and described above.
